(19) United States
(12) Patent Application Publication
(10) Pub. No.: US 2008/0281653 A1
(43) Pub. Date: Nov. 13, 2008

(54) System and method for implementation of procedure tracking

(75) Inventor: Hilik Goldstein, Tel Aviv (IL)

Correspondence Address: TIAJOLOFF & KELLY, CHRYSLER BUILDING, 37TH FLOOR, 405 LEXINGTON AVENUE, NEW YORK, NY, 10174, US

(73) Assignee: CrisAid Sarl, Geneva (CH)

(21) Appl. No.: 11/800,685

(22) Filed: May 7, 2007

(51) Int. Cl. G06F 9/44; G06Q 40/00

(52) U.S. Cl. 705/7; 705/36 R

(57) ABSTRACT

A method for enabling managers/users to track the implementation of a procedure made up of many activities, within a large number of categories and over a prolonged period of time. The method includes entering data on the procedure and displaying activities that require attention within a specific category. The method also includes activating one of the categories requiring the manager's/user's attention and clicking a completed activity to open a window that displays any existing data for the activity, such that tracking of the implementation of the procedure is enabled.

### FIELD OF THE INVENTION

The present invention relates generally to systems and methods for procedure tracking, and more particularly to a system and method for providing an organization with procedures for tracking many activities over a prolonged period of time.

### BACKGROUND OF THE INVENTION

Organizational procedure tracking is exemplified by issuance of an initial public offering (IPO). IPO firms have two sets of customers: those buying products and those buying shares. Sometimes the two are the same. For example, in preparation of its upcoming IPO, Deutsche Telekom heavily advertised on TV to both its customers and potential share buyers. It is important for entrepreneurs to talk not only to their customers, but also to the investment community.

### Advantages

Almost all companies go public primarily because they need money. All other reasons are of secondary importance. The typical (firm-commitment) IPO raises $20-40M, but offerings of $100 M are not unusual either. This can vary widely by industry.

Public firms tend to have higher profiles than private firms. This is important in industries where success requires customers and suppliers to make long-term commitments. For example, software requires training and no manager wants to buy software from a firm that may not be around for future upgrades, improvements, bug fixes, etc. Indeed, the suppliers' and customers' perception of company success is a self-fulfilling prophesy.

### Disadvantages

Public companies must continuously file reports with the SEC and the exchange they list on. They must comply with certain state securities laws (“blue sky”), NASD and exchange guidelines. It costs money and discloses information to competitors.

Outsiders often could take control and even fire the entrepreneur. Now, there are effective anti-takeover measures, but what investor wants to pay a high price for a company in which poor management could not be replaced?

An IPO is a costly undertaking. A typical firm may spend about 15-25% of the money raised on direct expenses. Even more resources are spent indirectly (management time, disruption of business).

All IPO participants in the coalition are jointly and severally liable for each others' actions. In practice, this means that they were routinely sued for various omissions in the IPO prospectus when the public market valuation fell below the IPO offering price. Congress recently passed The Private Securities Litigation Reform Act of 1995. The Act protects disclosure of firm projections, and (to the best of my knowledge) forced the suing shareholder to have a substantial participation in the firm. Although nothing can eliminate law suits, the Act reduces the likelihood of successful suits and thus influences settlement terms.

Therefore, it would be advantageous to provide a system and method for providing an organization with procedures for tracking many activities over a prolonged period of time.

### SUMMARY OF THE INVENTION

Accordingly, it is a principal object of the present invention to provide a system that enables managers to track the implementation of a procedure made up of many activities, within a large number of categories and over a prolonged period of time.

It is another principal object of the present invention to provide a system that system allows a manager to track a large number of simultaneous procedures and activities and to access and bring to bear historic information.

It is a further principal object of the present invention to provide a system based on a database that defines the procedures, categories and activities that require documentation, the additional information that needs to be collected during execution of the procedure and priorities of different actions.

A method is disclosed for enabling managers/users to track the implementation of a procedure made up of many activities, within a large number of categories and over a prolonged period of time. The method includes entering data on the procedure and displaying activities that require attention within a specific category. The method also includes activating one of the categories requiring the manager's/user's attention and clicking a completed activity to open a window that displays any existing data for the activity, such that tracking of the implementation of the procedure is enabled.

The information that the user enters and which is available to the manager includes: remarks and critical data, related documents, and the time of the action.

The data structure is defined hereinafter by the following information entities:
Procedure—a collection of activities, for example an initial public offering (IPO), which needs to be tracked and documented. The order of activities and their documentation is important.
Category—a division of activities into fields of activities.
Activity—an atomic action that requires reporting. Each activity is arranged in the way it needs to be performed following activities preceding it.
Log—a database that holds all the information collected during the execution of activities

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1 is a screenshot illustration of the main screen of the user interface for tracking an initial public offering (IPO), for example, constructed in accordance with the principles of the present invention;

FIG. 2 is a screenshot illustration of the screen used to enter data on the IPO, constructed in accordance with the principles of the present invention;

FIG. 3 is a screenshot illustration of the screen used to activate a category requiring the user's attention, constructed in accordance with the principles of the present invention;

FIG. 4 is a screenshot illustration of the screen displaying activities that require attention within a specific category, constructed in accordance with the principles of the present invention;

FIG. 5 is a screenshot illustration of the screen, wherein clicking a completed activity has opened a window that displays any existing data for the activity, constructed in accordance with the principles of the present invention; and

FIG. 6 is a screenshot illustration of the screen, wherein many categories requiring attention are shown, constructed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

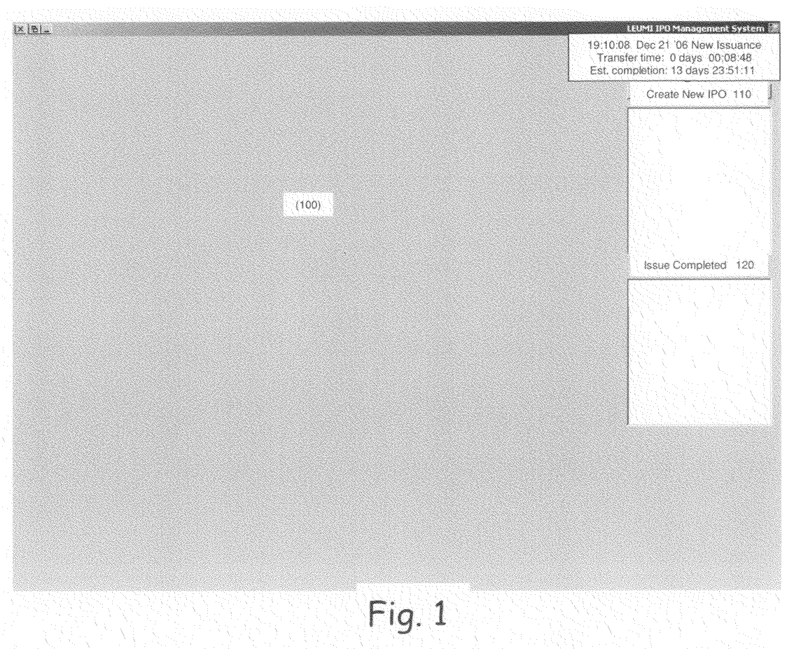

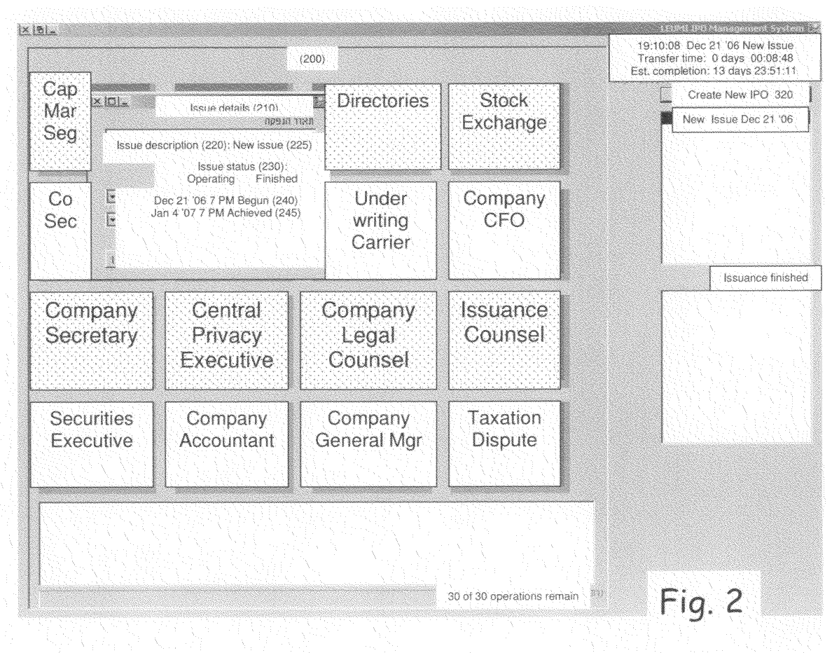

FIG. 1 is a screenshot illustration of the main screen 100 of the user interface for tracking an initial public offering (IPO), for example, constructed in accordance with the principles of the present invention. After clicking the “Create New IPO” button 110, the screen of FIG. 2, described hereinbelow appears. After completion of the IPO, the user clicks the “Issue Completed” button 120.

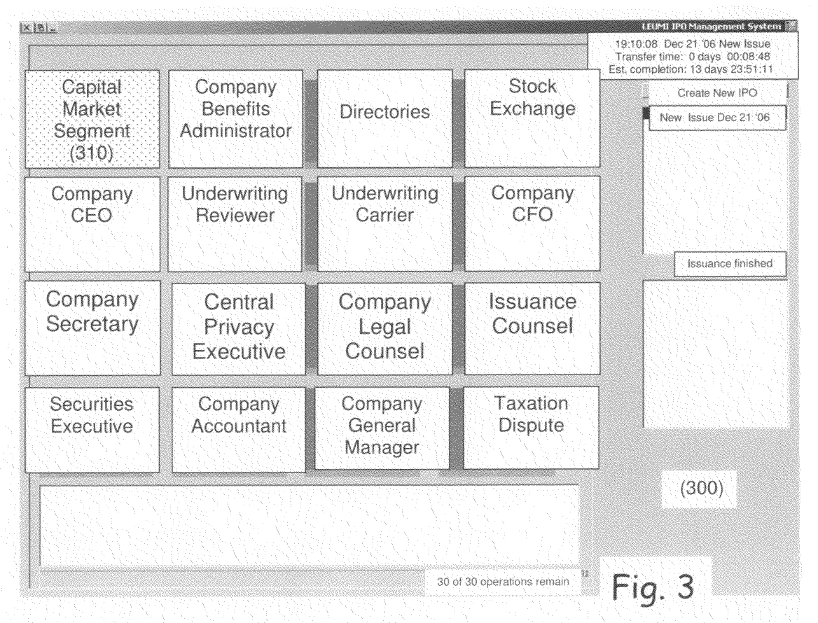

FIG. 2 is a screenshot illustration of the screen used to enter data on the IPO 200, constructed in accordance with the principles of the present invention. The user can enter issue details 210, a name and description 220 and 225, activity status 230, start dates 240 and deadline 245. After entering data on the IPO, the screen of FIG. 3, described hereinbelow appears.

FIG. 3 is a screenshot illustration of the screen which indicates what the categories are for the activity and in which category there are activities that require the user's attention 300, constructed in accordance with the principles of the present invention. These categories are indicated by a speckled background. In FIG. 3 only the Capital Market Segment category button 310 is speckled. Clicking category button 310 will lead to the next screen.

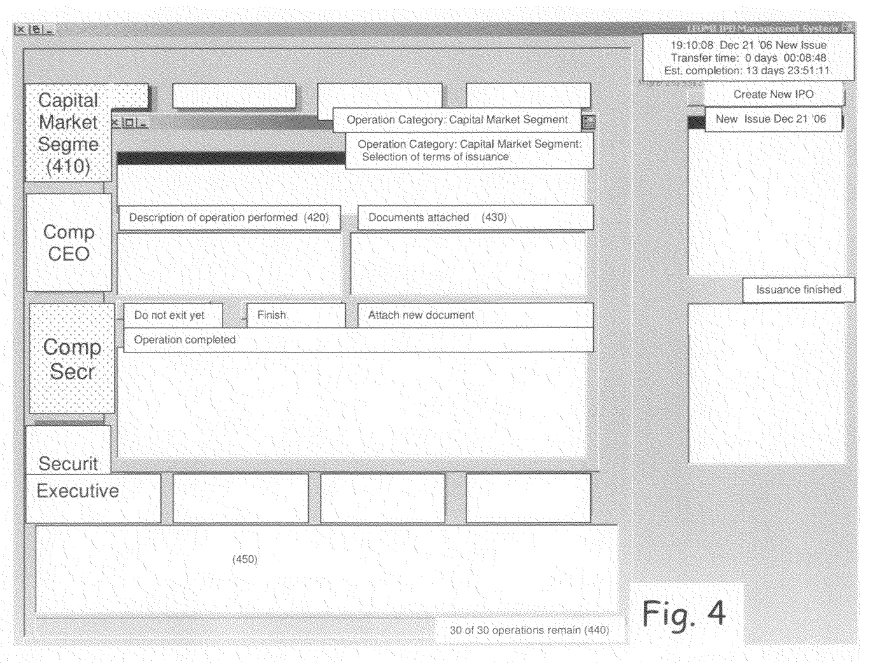

FIG. 4 is a screenshot illustration of the screen displaying activities that require attention within a specific category 410, constructed in accordance with the principles of the present invention. Each activity may depend on the previous completion of one or more activities, so that all of the activities in a specific category will not appear immediately, but only after the prerequisites have been met.

This screen allows the user to enter a link to documents attached 430 and free text that describes the activity 420. The bottom part of the screen will show activities that were already completed 440. Since in this example, at this time, 30 of 30 remain, no completed activities are listed 450.

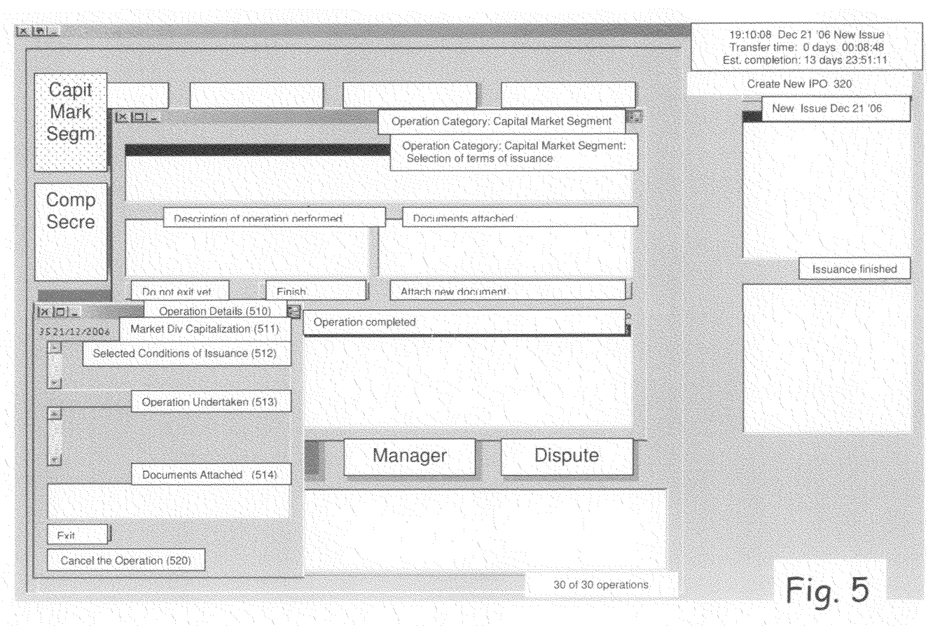

FIG. 5 is a screenshot illustration of the screen, wherein clicking a completed activity has opened a window that displays any existing data 510 for the activity, constructed in accordance with the principles of the present invention. Such activities include Market Division Capitalization 511, Selected Conditions of Issuance 512, Operation Undertaken 513 and the Operation Undertaken 513. If there is a need, this screen lets the user cancel 520 the activity in order to reenter the data.

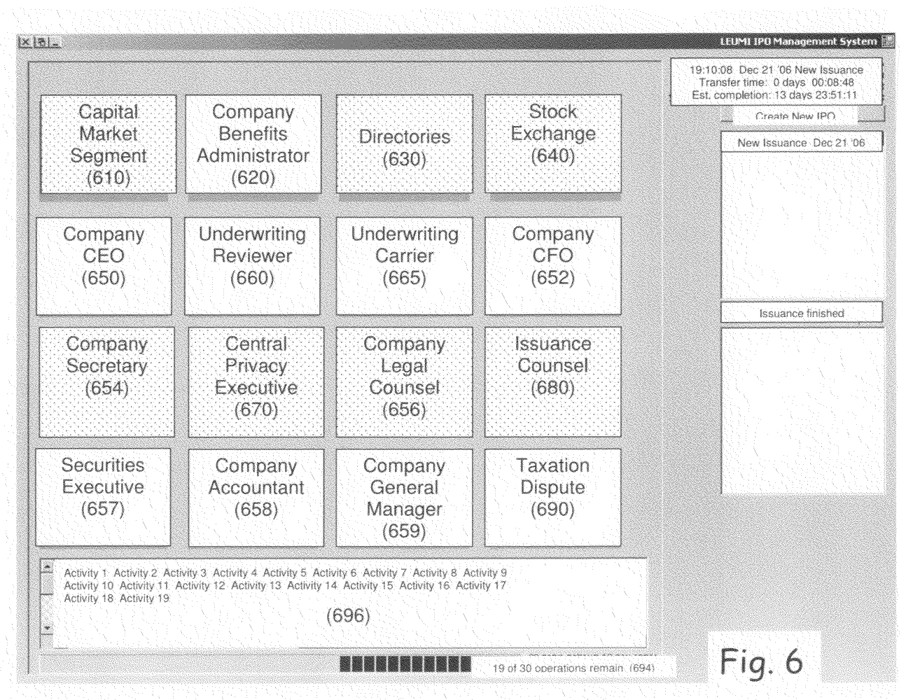

FIG. 6 is a screenshot illustration of the screen, wherein many categories requiring attention are shown, constructed in accordance with the principles of the present invention. The exemplary activities for issuing an Initial Public Offering are Capital Market Segment 610, Company Benefits Administrator 620, Directories 630, Stock Exchange 640, Company CEO 650, Underwriting Reviewer 660, Underwriting Carrier 665, Company CFO 652, Company Secretary 654, Central Privacy Executive 670, Company Legal Counsel 656, Issuance Counsel 680, Securities Executive 657, Company Accountant 658, Company General Manager 659 and Taxation Dispute 690.

During the execution of a procedure, new activities for execution will arise in other categories, sometimes even in several categories simultaneously.

The bottom of screen lists all the activities that were completed during the procedure. A progress bar will appear at the bottom of the screen, to track the progress of the procedure, and it describes graphically and textually how many actions were completed and how many actions in total the procedure contains. Since in this example, at this time, 19 of 30 remain 640, 11 completed activities are listed 650.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for enabling managers/users to track the implementation of a procedure made up of many activities, within a large number of categories and over a prolonged period of time, said method comprising:
entering data on the procedure;
displaying activities that require attention within a specific category;
activating one of the categories requiring the manager's/user's attention; and
clicking a completed activity to open a window that displays any existing data for the activity,
such that tracking of the implementation of the procedure is enabled.

2. The method of claim 1, wherein the procedure is an initial public offering (IPO).

3. The method of claim 1, further comprising canceling an activity in order to reenter said data.

4. The method of claim 1, wherein entering said data comprises at least one of issue details, a name and description, activity status, start dates and deadline.

5. The method of claim 1, wherein activating one of the categories comprises clicking a category button.

6. The method of claim 1, wherein at least one activity has at least one prerequisite.

7. The method of claim 16, wherein each activity may depend on the previous completion of at least one other activity, so that some of the activities in a specific category appear at a later time after said at least one prerequisite has been met.

8. The method of claim 1, further comprising entering a link to attached documents after said activating step.

9. The method of claim 1, further comprising entering a link to free text that describes the activity after said activating step.

10. The method of claim 1, further comprising showing activities that were already completed.

11. A system for enabling managers/users to track the implementation of a procedure made up of many activities, within a large number of categories and over a prolonged period of time, said method comprising:
provision for entering data on the procedure;
provision for displaying activities that require attention within a specific category;
provision for activating one of the categories requiring the manager's/user's attention; and
provision for clicking a completed activity to open a window that displays any existing data for the activity,
such that tracking of the implementation of the procedure is enabled.

12. The system of claim 11, wherein the procedure is an initial public offering (IPO).

13. The system of claim 11, further comprising provision for canceling an activity in order to reenter said data.

14. The system of claim 11, wherein provision for entering said data comprises at least one of issue details, a name and description, activity status, start dates and deadline.

15. The system of claim 11, wherein provision for activating one of the categories comprises clicking a category button.

16. The system of claim 11, wherein at least one activity has at least one prerequisite.

17. The system of claim 6, wherein each activity may depend on the previous completion of at least one other activity, so that some of the activities in a specific category appear at a later time after said at least one prerequisite has been met.

18. The system of claim 11, further comprising provision for entering a link to attached documents after said activating step.

19. The system of claim 11, further comprising provision for entering a link to free text that describes the activity after said activating step.

20. The system of claim 11, further comprising provision for showing activities that were already completed.
